(19) United States
(12) Patent Application Publication
(10) Pub. No.: US 2012/0051060 A1
(43) Pub. Date: Mar. 1, 2012

(54) Reflector Assembly and Beam Forming

(75) Inventor: Michael Fernand Alexander Derome, London (GB)

(73) Assignee: QINETIQ LIMITED, Hampshire (UK)

(21) Appl. No.: 13/319,642

(22) PCT Filed: May 13, 2010
(86) PCT No.: PCT/GB10/00963

§ 371 Date: Nov. 9, 2011

(30) Foreign Application Priority Data
May 14, 2009 (GB) 0908228.0

(51) Int. Cl. F21V 7/04; F21V 7/08; F21V 7/07; F21V 29/00; F21V 7/05

(52) U.S. Cl. 362/294; 362/298; 362/301

(57) ABSTRACT

A beam forming apparatus for forming a beam in a forward direction including a first reflector arranged to receive light from said source and to reflect it rearward, and a second reflector arranged to receive light from said first reflector and to reflect it forward. The rearmost reflector is hyperbolic in form, and the front reflector is advantageously elliptical. This arrangement offers multiple different beam patterns of varying and controllable concentration to be achieved in a consistent and predictable manner.

The present invention relates to reflector assemblies and beam forming, and particularly, but not exclusively to a reflector assembly for an LED light source.

A large number of luminaire designs exist for modifying the pattern of light emitted from a lamp or source. Many such designs address the problem that an incandescent source often has a generally omnidirectional light emission pattern, and include a paraboloidal or other concave reflector wrapped around the rear of the source. Additional or secondary reflectors and lenses can be included, and highly complex, multifaceted designs can result.

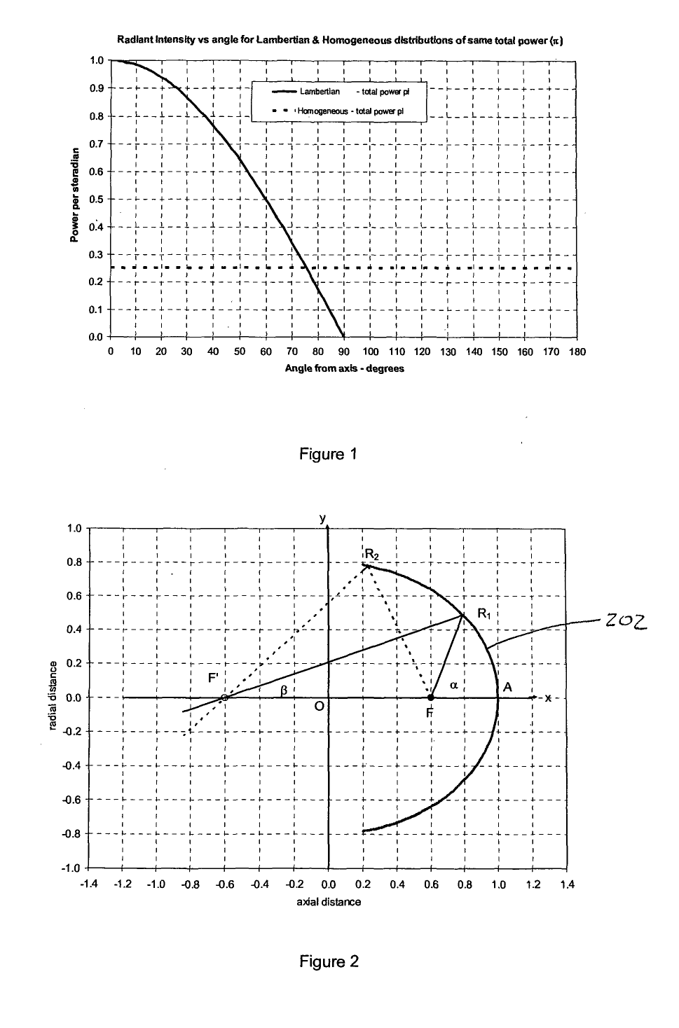

Lenses can also be incorporated into luminaires to provide additional shaping of the pattern of light emitted. LED light sources tend to emit light in a Lambertian pattern as illustrated in FIG. 1, and lenses have proved popular in manipulating this output pattern to be more suited for an intended use, for example narrowing the beam or creating a side-emission pattern. Common lens types however suffer problems in sharply defining certain beam patterns, and can lead to spectral dispersion.

It is an object of one aspect of the present invention to provide improved beam forming and reflector devices.

Accordingly there is described herein beam forming apparatus for forming a beam in a forward direction along a beam axis, said apparatus comprising a light source; a first reflector arranged to receive light from said source and to reflect it rearward, said first reflector having a first aperture therein; a second reflector arranged to receive light from said first reflector and to reflect it forward through the aperture in said first reflector; and wherein the first reflector is arranged to direct incident light from said light source towards one or more foci rearward of the second reflector.

This arrangement provides advantage in that light emitted at increased emergence angles are redirected by double reflection and re-emerge at lesser angles, thus concentrating the light energy into an output beam.

Light striking the first reflector is generally divergent, but is reflected to be directed generally backwards (opposite to the beam direction) and to be generally convergent. This once-reflected light is then re-reflected by the second reflector, to subsequently exit through the aperture from which the desired beam is emitted. The arrangement of reflectors is such that the once-reflected light is reflected for a second time while it is still convergent, which is to say before it has crossed the optical axis. In this way, adverse effects associated with rays striking the light source, which is generally located on or near the optical axis, are reduced or avoided.

The second reflector can be substantially planar or flat. A flat reflector is simple and inexpensive to manufacture, and the use of a flat reflector simplifies the relationship with the first reflector and the overall geometry of the apparatus. In embodiments having a flat second reflector, it will typically be arranged perpendicular to the optical, or beam axis.

The second reflector may advantageously include a second aperture, preferably adapted to accommodate the light source. As explained in greater detail below, the light source may be mounted on the second reflector in embodiments, and this is useful for mounting and locating the light source. Further advantage may be made of this arrangement by providing a heatsink coupled to the second reflector. In this way, the heatsink has a high thermal coupling to the light source, without adversely affecting the optical properties of the device.

The arrangement of reflectors is not limited to direct all rays reflected from the first reflector towards a single focus. Rather, rays emerging at different angles may be directed towards different foci. For example the reflectors could be arranged to have discrete portions having common optical properties resulting an a discrete number of distinct foci, or the reflectors could have continuously varying properties, resulting in a continuous locus of foci.

There is also described a reflector assembly for a luminaire, said assembly comprising a substantially flat reflector facing in a forward direction, and a concave reflector arranged opposite to and facing said flat portion, said concave reflector having a an aperture therein, wherein said concave reflector is adapted to direct incident light emitted by a light source onto said flat reflector, and wherein said flat reflector is adapted to receive light from said concave reflector, and direct it through said aperture.

In this way, there has been proposed a method for forming a beam in a beam direction along an optical axis, said method comprising reflecting divergent rays emerging from a light source at angles above a given threshold angle with respect to the optical axis, to produce convergent rays in a direction generally opposite said beam direction; allowing divergent rays emerging from said light source at angles less than said threshold angle to form a beam unreflected; further reflecting said convergent rays prior to their crossing the optical axis, to direct them generally in the beam direction; and allowing said further reflected rays to join said unreflected rays to form a beam.

Above has been described arrangements which are principally concerned with the production of an intense narrow beam from a point source whose output distribution was typically homogeneous or Lambertian. The point source was placed on the axis of rotation between the two reflectors.

It is desirable however to be able to offer different degrees of beam sharpening for a variety of applications.

According to a first aspect of the invention, there is provided beam forming apparatus for forming a beam in a forward direction along a beam axis, said apparatus comprising a light source; a first reflector arranged to receive light from said source and to reflect it rearward, said first reflector having a first aperture therein; a second reflector arranged to receive light from said first reflector and to reflect it forward through the aperture in said first reflector; wherein the first reflector is arranged to direct incident light from said light source towards one or more foci rearward of the second reflector; wherein said second reflector is hyperbolic.

For a curved first reflector, the use of a hyperbolic second reflector results in a complex geometrical interaction between two curved surfaces, and the potential for extremely complex calculation for achieving a highly focussed beam. As will be described below in greater detail however, it has been found that arranging for the second reflector to have the form of one of the limbs of a hyperbola offers multiple different beam patterns of varying and controllable concentration to be achieved in a consistent and predictable manner. A ‘suite’ or set of beam forming devices are therefore made possible, by varying particular ones of a limited number of variables, to give a specific desired output result.

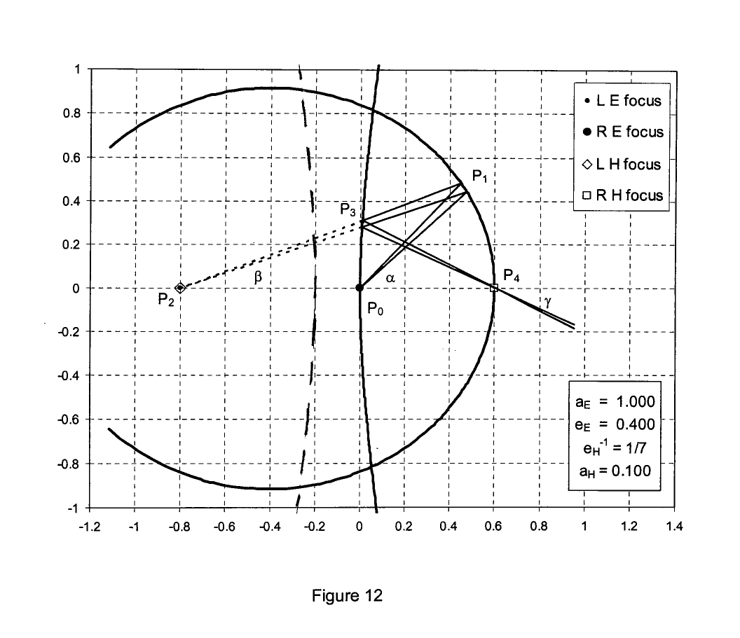

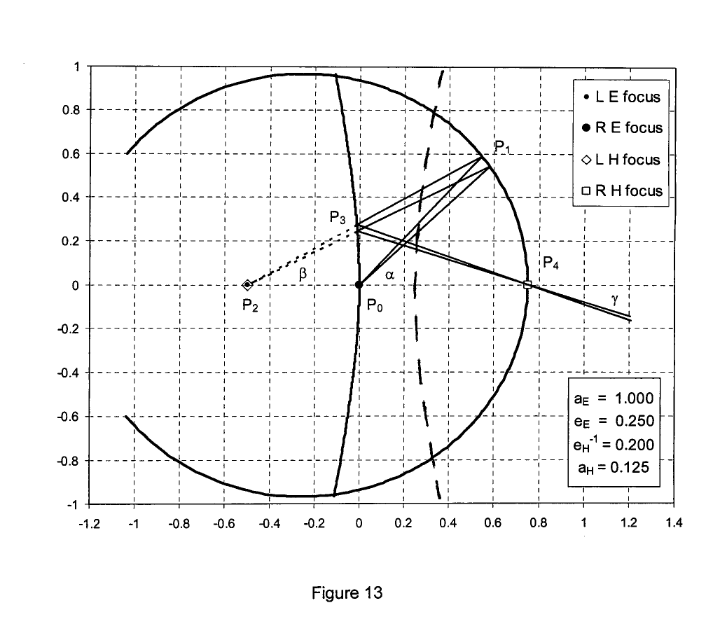

The second reflector may be concave or convex according to the desired resulting beam properties. Here concave and convex are defined from a point of reference forward of the apparatus, such that the second reflector in FIG. 12 is concave, and the second reflector in FIG. 13 is convex. Both convex and concave designs can be achieved by using the different limbs of a parabola defining the cross section of the second reflector. This enables consistent relationships and placement of hyperbola focus to be observed for both convex and concave designs. As will be described below in more detail, in a special case, the hyperbolic reflector may be flat or planar. This typically results in a planar second reflector, perpendicular to the optical axis.

In one advantageous embodiment the first reflector is elliptical, or prolate spheroidal.

Advantageously the focus of the hyperbolic second reflector which lies behind the second reflector is coincident with the rearmost focus of the elliptical first reflector. Desirably the focus of the hyperbolic second reflector which lies forward of the second reflector lies at the base of the first reflector, in the aperture of the first reflector.

In embodiments having an elliptical first reflector, the foremost focus of the elliptical first reflector preferably lies at the base of the second hyperbolic reflector, and it is further desirable for the light source to be located at this point.

In embodiments where the light source is located substantially at or on the surface of the second reflector, ancilliary features of the light source, such as control circuitry (eg the chip for an LED) or a heatsink can be mounted directly behind the second reflector, optionally mounted to the rear face of the secondary reflector. This allows a compact design to be realised with advantageous cooling properties.

The above notes methods and apparatus for manipulating light by arranging for a certain portion of the light to undergo two reflections. Embodiments of the invention however may be arranged to take such twice reflected light, and cause it to be similarly reflected two more times in a further reflection stage, substantially similar to the first. Thus the above described aspects can be ‘stacked’ to provide embodiments having two or more sets of reflectors, or reflection steps, the first substantially as already described, and the second operating in an equivalent manner, but using the output of the first as a light source or to provide incident light. The parameters of each stage can be manipulated independently to provide the desired light shaping effect. This concept can be extended to three or more stages if desired.

It has been shown that for certain ‘stacked’ embodiments at least, that a two stage reflector assembly provides the effect of a single stage reflector assembly having a curved reflector with a greater degree of curvature than the curved reflectors of each individual stage. This allows a similar light concentration effect with reduced curvature reflectors, which can be advantageous to a designer as will be explained in greater detail below.

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

FIG. 1 shows a light emission pattern for an LED

FIG. 2 illustrates a prolate spheroidal reflector

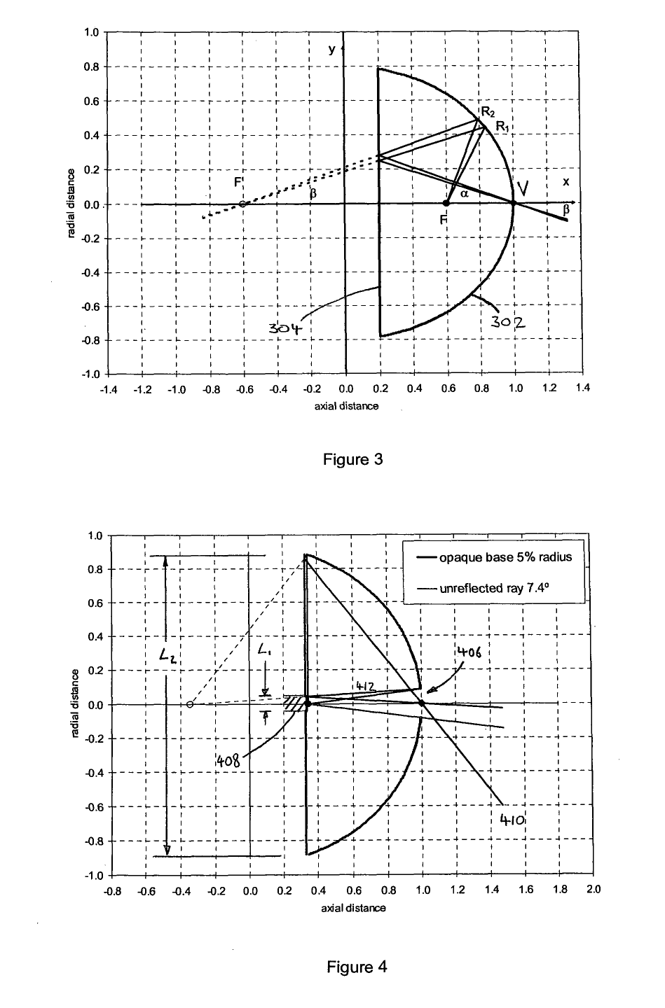

FIG. 3 illustrates a reflector arrangement having a planar rear reflector.

FIG. 4 illustrates a reflector arrangement in which a light source is mounted substantially in the plane of the rear reflector.

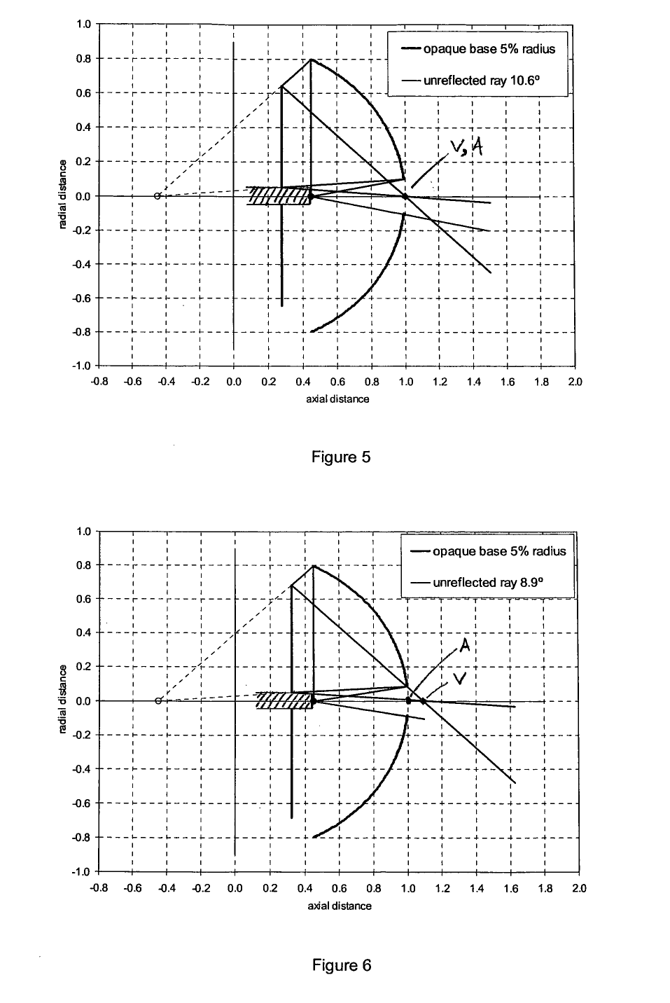

FIGS. 5 and 6 illustrate the variation in position of the convergence point of a reflector arrangement.

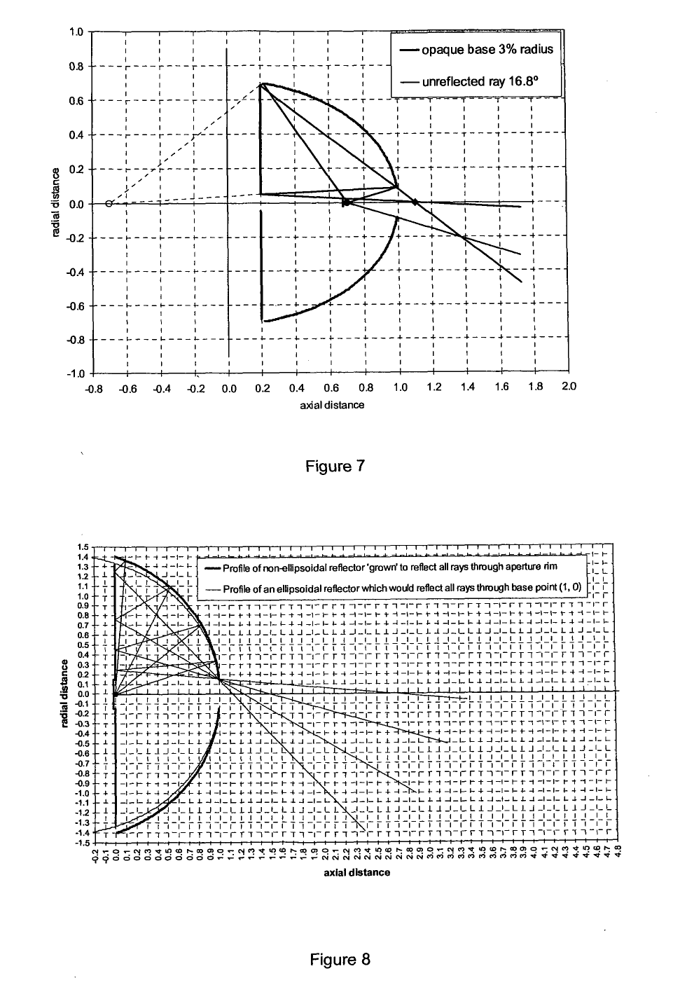

FIG. 7 shows a reflector arrangement capable of accommodating a light source which emits light with a divergence angle greater than 90 degrees.

FIG. 8 shows a reflector arrangement having a non-prolate spheroidal front reflector.

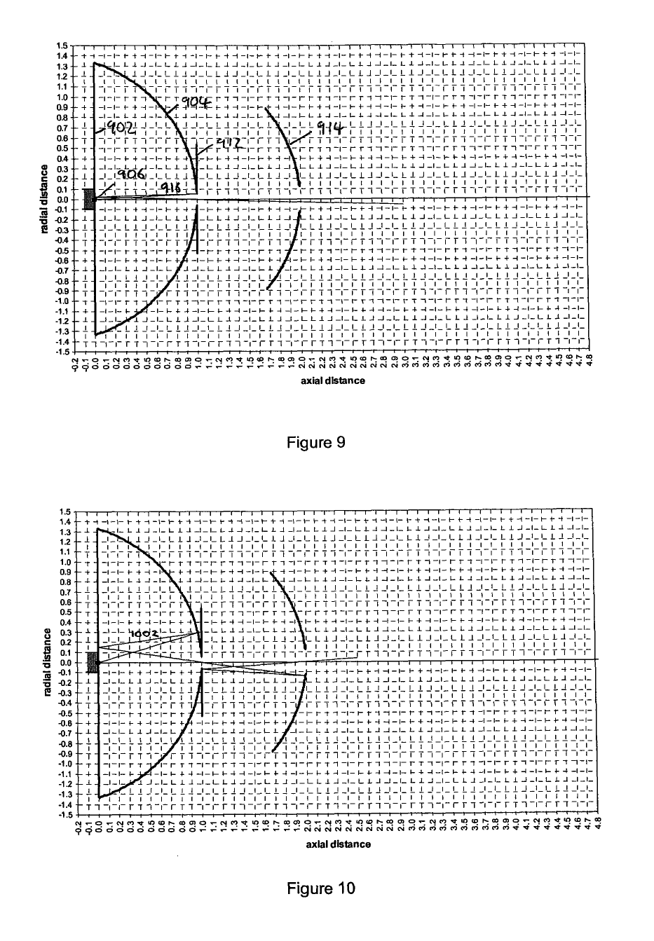

FIGS. 9, 10 and 11 demonstrate the effects of two reflector assemblies stacked in series.

FIGS. 12, 13, and 14 illustrate arrangements having a hyperbolic reflector.

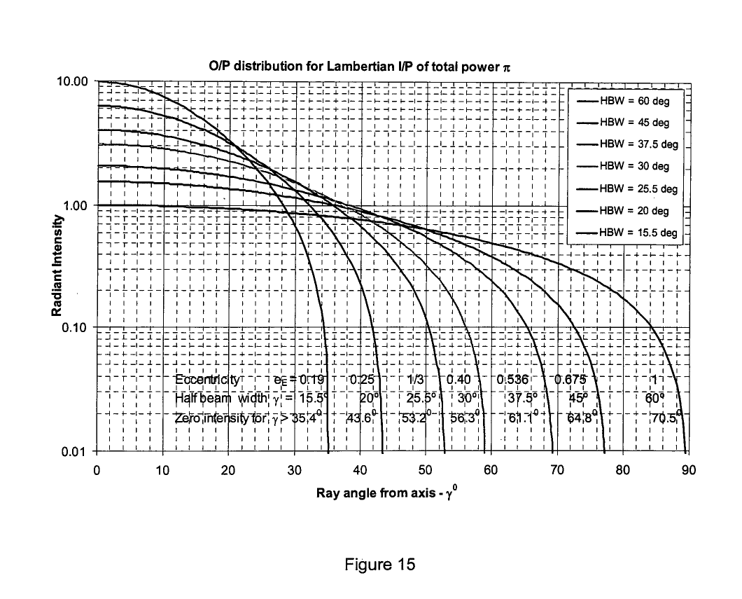

FIG. 15 shows output light distributions for arrangements employing a hyperbolic reflector.

Prolate spheroidal reflectors operate on the principal that light rays emitted from a light generating source at one focus F are reflected through the second focus F′, as shown in FIG. 2. The cross section through the optical axis of such a reflector results in an ellipse, or a portion of an ellipse, and prolate spheroidal reflectors adopt the form of the surface of revolution about the optical axis of such an ellipse. Such reflectors are sometimes referred to as elliptical or ellipsoidal. Returning to FIG. 2, it can be demonstrated that rays striking the reflector 202 (having an eccentricity e=0.6) nearer the base portion (ie further to the right as viewed in FIG. 2) are concentrated by a greater amount, ie. the ratio of incident to reflected energy per steradian is greater, than those rays striking the reflector towards the rim. The base of the reflector, marked A in FIG. 2, is its point of intersection with the optical axis.

Considering the emission pattern of FIG. 1 of a typical LED however, there is little point using a forward facing LED at the source of such a reflector, since little or no light is emitted beyond 90 degrees from the forward pointing optical axis, and therefore what little light is incident on the reflector, will tend to be concentrated only weakly.

A potential solution is to reverse the direction of the light source or LED. In an arrangement where an LED is facing the reflector substantially all emitted light will be incident on the reflector, and a significant portion will be directed toward the high concentration region at the base of the reflector. In principle this is an attractive design, however in practice the finite size of the light source, together with the means for supporting the source and any electrical supply will block a significant portion of reflected light.

In FIG. 3, The prolate spheroidal reflector 302 is the same as that shown in FIG. 2, but a flat or planar reflector 304 is included to intersect light reflected from the curved reflector 302 before it converges at focus point F′. Planar reflector 304 crosses the optical axis at a point half way between focus F′ and the base of the curved reflector 302, so as to cause twice reflected light to pass through a new, virtual focal point V (effectively the reflection of F′ in reflector 304). A small “exit” aperture is included around the base of the reflector 302 of sufficient size to allow through the twice reflected light. Where new focal point V lies on the surface of the prolate spheroid (ie at its base A), this hole or aperture can in theory be made very small, but in reality practical constraints make it desirable for the hole to be enlarged somewhat, as will be explained below. As the aperture is enlarged, it will be understood that a plane through the aperture intersects the optical axis at an offset from base point A. The small conical beam emerging from the virtual source V has identical emergence angle and concentration as the original one which would otherwise have emerged from F′ except that its direction has been reversed. If the flat mirror crossed the axis at a point to the left or right of the halfway point the virtual source point will move to the left and right respectively of the base point A with unchanged exit angles and concentrations.

A typical LED light source will have an opaque base or physical envelope 408 which blocks light and prevents certain reflection paths within a reflector assembly as shown in FIG. 4. FIG. 4 shows an arrangement similar to that of FIG. 3, but where the geometry has been selected such that the light source lies on or very close to the plane of the flat reflector (eccentricity e=0.345). The light source is also shown to have a physical envelope 408 having a radius L₁ of 5% of the radius of the reflectors L₂. To accommodate the light source, the central portion of the flat reflector is removed.

It can be seen that for this configuration, a ray 412 emitted by the light source at an angle of just greater than 7.4° is reflected from the curved reflector and strikes the planar reflector at its limit where it is adjacent to the opaque portion of the light source for re-reflection through the aperture 406. It will be understood that a ray emitted at a lesser angle will strike the opaque base portion and will not be re-reflected. 7.4° is therefore the minimum reflectable emergence angle for intended operation of the device. Similarly, 90° is the maximum angle as shown by ray 410.

In an arrangement where the light source sits forward of the planar reflector (eg FIGS. 3 and 5) then light at small emergence angles may be doubly reflected, but still impinge on the opaque blocking portion of the light source on route to the “exit” aperture. In this way, the blocking portion of the light source still determines the minimum reflectable emergence angle. In such cases, the aperture in the flat reflector can be made larger than the size of the opaque portion of the light source (up to a limit determined by the minimum reflectable emergence angle) without loss of performance.

It is noted above that the size of the aperture in the forward, curved reflector can theoretically be made very small in the above examples, since light is theoretically concentrated to a point at this position. However, doing so causes light to be reflected onto the opaque portion of the light source and hence ‘lost’, which light would otherwise usefully emerge unreflected. From the above consideration of minimum emergence angle and with reference to FIG. 4, it can be seen that a desirable size for aperture 406 exists where it just reflects emitted light at the minimum emergence angle, allowing light at all lesser angles to emerge unreflected. This increased size can be further exploited with regard to the position of the flat reflector, as will be explained below.

The minimum reflectable emergence angle increases with an increase in the ratio of the opaque base radius of the light source to the radius of the device. This angle also increases with the eccentricity of the reflector as can be seen by comparison with FIG. 5, where the eccentricity e=0.45. A larger minimum reflectable emergence angle reduces the proportion of emitted light which is concentrated by action of the double reflection.

Given the parameters described above, the performance envelope may be further improved however, taking advantage of the fact that the aperture in the forward, curved reflector can be made greater than the beam diameter at that point. By moving the plane mirror in a forward direction closer to the source, the virtual, or reflected, focal point V moves correspondingly along the axis beyond the base A of the ellipse or prolate spheroid and allows the radius of the aperture in the planar reflector to be reduced while still allowing all reflected and un-reflected light through. The optimum position allowing the largest ratio of reflected to un-reflected light for a given eccentricity is reached when the ray reflected from the largest angle (90° in the case of FIGS. 5 and 6) just passes the edge of the aperture in the curved reflector. In this way, light from the source incident on the outer edge of the first reflector, and twice reflected, passes thorugh an annular region of the first aperture. This is illustrated in FIG. 6, which shows the light source and curved reflector as in FIG. 5, but with the planar reflector displaced along the x axis (optical axis). For this condition, the largest ratio of reflected to un-reflected light is then determined by the eccentricity of the prolate spheroid, and the relative size of the blocking portion of the source.

Devices according to the present invention work equally well for a source emitting light rays at angles greater than 90° from its forward axis of symmetry (i.e. into solid angles between 2π and 4π). To provide the desirable condition that all light emitted must either emerge un-reflected or be twice reflected, the geometry should not allow light to strike the flat mirror before the prolate spheroidal reflector. This places a lower limit on the value of eccentricity for an elliptical reflector. An example is illustrated in FIG. 7. The prolate spheroid in this design has an eccentricity of 0.7, and the opaque blocking radius of the lamp or light source is 3% of the device radius. It is sufficient to cope with an emitter whose largest exit angle is 125°.

An advantageous design for a reflector can therefore be obtained in the following way. For a given eccentricity and size (semi major axis or alternatively radius) the light source is placed at the appropriate focus and the flat reflector positioned to focus twice reflected light at the base of the prolate spheroid. The physical size of the opaque portion of the light source determines the minimum angle at which light emerging from the source can be doubly reflected, and hence concentrated, and the aperture in the curved reflector is sized to just reflect light emerging at this angle. Fine tuning of performance can then be performed by adjusting the spacing between the reflectors in order to move the twice reflected virtual focus forward of the base of the prolate spheroid, and reduce the size of the aperture in the curved reflector accordingly, at the expense of light emerging from the source at very high angles (eg close to 90°). The aperture in the flat reflector can then be sized appropriately.

The table below shows the effect of changes in the shape and size of the forward, curved reflector against certain output measures or performance criteria. It is assumed the flat mirror is in the optimum position which minimizes the semi cone angle of un-reflected light (ie minimizes the aperture of the forward curved reflector. Note that increasing the size of the reflectors reduces the ratio of opaque-blocking-radius of the light source to the maximum radius of the reflector, which itself reduces the semi-cone angle of the un-reflected portion of the light beam.

| | Effect on output measure | |
|---|---|---|
| | Increase in shape | Linear increase |
| | parameter (eg. eccentricity) | in size of |
| | of forward reflector while | reflectors |
| OUTPUT measure or | retaining base to rear | (magnification |
| performance criteria | reflector distance) | parameter) |
| Concentration | Increases | No change |
| Ray exit angle for a given | Decreases | No change |
| entry angle | | |
| Max possible entry angle | Increases | No change |
| above 90° | | |
| (for ⅓ < e < 1 only) | | |
| Max radius of 1^{st} reflector | Decreases | Increases |
| Ratio of radius of opaque | Increases | Decreases |
| blocking portion of | | |
| source to max radius of 1^{st} | | |
| reflector | | |
| Ratio of minimum possible | Increases | Decreases |
| radius of aperture in 1^{st} | | |
| reflector to its max radius. | | |
| Min possible semi cone | Increases | Decreases |
| angle of un reflected | | |
| light | | |
| Max possible fraction of | Decreases | Increases |
| light reflected | | |

In the examples described above, eccentricity e is used as the shape parameter for embodiments having prolate spheroidal forward reflectors. Greater flexibility is afforded however, by providing a curved reflector the profile of which is not a prolate spheroid, and a suitable alternative shape parameter can be considered.

Considering FIG. 6, the exit ray from the highest entry angle (ie approximately 90°) is just able to exit the aperture in the curved reflector. All other exit rays, which pass through the virtual focus V, pass though the exit hole plane at a distance nearer the axis than its radius. This provides an opportunity for an alternative reflector design.

Suppose one starts with a prolate spheroid and flat mirror design such as the one shown in FIG. 6. Initially retaining a small element of the prolate spheroidal reflector around the beam exit aperture let a new surface of revolution grow outward having the property that each ray after double reflection emerges through the front reflector aperture near or at the edge of the aperture. This will result in a surface which is non-prolate spheroidal, and rays exiting the aperture and crossing the optical axis at a variety of focal points, and is illustrated in FIG. 8.

If the aperture in the curved reflector is just greater than the opaque light source base radius, then smallest entry ray would emerge parallel with axis having a focal point at infinity. As the angle at which light emerges from the source increases, the exit angles would increase also but the virtual source points on the axis would move from far to nearer the base of the reflector. The two main parameters in such a design are
Opaque light source base radius p
Curved reflector aperture r

To retain the desirable quality that all light is either twice reflected and concentrated or not reflected at all, the aperture should be chosen greater than the opaque light source radius. Such designs can be made to give local concentrations higher than the prolate spheroid could offer because the exit angles can be made smaller.

FIGS. 9 and 10 show how the basic concept of the two opposed reflector concept described above can be extended to a stacked, or nested arrangement, in which the beam emerging from the aperture of a first reflector assembly substantially as described above, can be considered as the light source for a second, similar reflector assembly.

A first flat base reflector 902 and a first prolate spheroidal reflector 904 are arranged as described above, with a light source 906 located on the plane of the base reflector. In this example, the light source is an LED with the opaque base portion arranged behind the flat reflector. A second flat or planar base reflector 912 is arranged so that it passes through the forward aperture of reflector 904, substantially parallel to reflector 902. The base A of reflector 904 therefore sits slightly forward of the plane of 912. Reflector 912 includes an aperture which substantially matches the forward (light output) aperture in reflector 904. A second prolate spheroidal reflector 914 is arranged with respect to reflector 912 as described above, to form a secondary reflector assembly, and includes a light output aperture.

Light rays emerging unreflected from the primary reflector assembly also pass through the secondary reflector assembly unreflected in this example. Light ray 916, emerging at 5° from the optical axis is incident on the edge of the reflector 904 and is reflected backwards, to be reflected again from base reflector 902. Ray 916 subsequently passes through the apertures of reflectors 904, 912 and 914 at an angle of 2.5°. Turning to FIG. 10, a light ray 1002 is shown in relation to the same apparatus as in FIG. 9. This time the light ray has an emergence angle of 17° from the optical axis. This ray is twice reflected by the primary reflector pair (902 and 904) resulting in an emergence angle of 8.6°. Ray 1002 is then reflected twice by the secondary reflector pair (912 and 914) to have a final emergence angle from the aperture of reflector 914 of 4.3°.

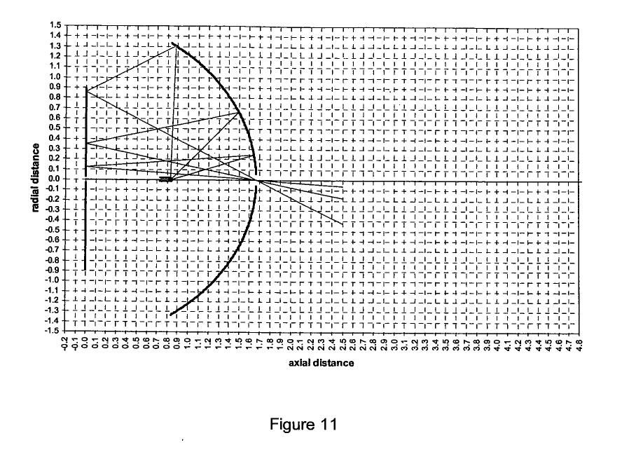

It can be calculated that such a two stage reflector assembly provides the effect of a single stage reflector assembly having a greater eccentricity. In FIGS. 9 and 10, each stage has an eccentricity of e=0.33, and the light concentrating effect is the same as for a single stage reflector assembly having eccentricity of approximately e=0.6, as shown in FIG. 11. Such a single stage reflector having an eccentricity greater than one third, would result in the light source being significantly forward of the base reflector, and would therefore be subject to various practical limitations concerning the opaque base portion, and mounting and electrical connection considerations.

Reflector stages could in theory be ‘stacked’ three times or more, to provide a greater concentration effect while maintaining curved reflectors having low eccentricities. For ‘stacked’ assemblies having multiple reflector stages arranged in series, the reflectors need not be purely prolate spheroidal, and other profiles or mixtures of profiles as described above can be included.

In the arrangements described above a flat secondary reflector has been used. The principles described above however can be applied to other shapes of secondary reflector. There will now be described arrangements having a hyperbolic ‘base’ or secondary reflector, and it will be appreciated that features described above may be used in conjunction with arrangements as described below.

It is known that the shape and size of an ellipse, a closed curve, is completely described by two parameters, its eccentricity e_{E} and semi-major axis size a_{E}, respectively. The distance between the two bases (points where the ellipse crosses the x-axis) is 2a_{E} and the distance between the two foci is 2a_{E}e_{E}, where e_{E} varies from 0 for a circle (both foci coincide) towards 1 from below for a single long thin closed curve. The ellipse around each focus approaches a parabola in this case.

Similarly the shape and size of a hyperbola, consisting of two separate “limbs”, is completely described by two parameters, its eccentricity e_{H} and semi-major axis size a_{H} respectively. The distance between the two bases (points where the hyperbola crosses the x-axis) is 2a_{H} and the distance between the foci is 2a_{H}e_{H}, where e_{H} varies from ∞ (1/e_{H}=0) for a single straight line (both bases coincide) towards 1 from above (1/e_{H}=1 from below) for two separate long thin curves. The hyperbola around each focus approaches a parabola in this case.

Referring to FIGS. 12 and 13, Two closely spaced rays of light leaving the source at point P₀, the right focus or foremost focus of the ellipse, define a narrow beam of light in a small solid angle at semi-cone angle α with respect to the axis of rotation. Upon reflection from the ellipse at P₁ the beam, by virtue of the reflection property of an ellipse, converges towards the left focus or rearmost focus of the ellipse at point P₂ at a semi-cone angle of β. Before reaching P₂ the beam is reflected at P₃ from the limb of the hyperbola which passes through the source point P₀ at its base. Since P₂ is also the left focus or rearmost focus of the hyperbola, the beam is reflected, by virtue of the reflection property of a hyperbola, towards point P₄ the right focus or foremost focus of the hyperbola. P₄ on the axis of rotation, is also the base of the ellipse, ie the point where the elliptical reflector intersects the central or beam axis. The light then diverges at a semi-cone angle of γ. The point P₄ acts as a virtual source point. The limb of the hyperbola not used as the second reflector is shown dashed line in FIGS. 12 and 13. The emerging light distribution is changed from the original by the two reflections. The output distribution at semi-cone angle γ depends on:
The emergence angle γ relative to the input angle α.
The Ratio dΩ_{γ}/dΩ_{α} between the infinitesimal input and output solid angles.
The radiant intensity of the input distribution at the input angle α.

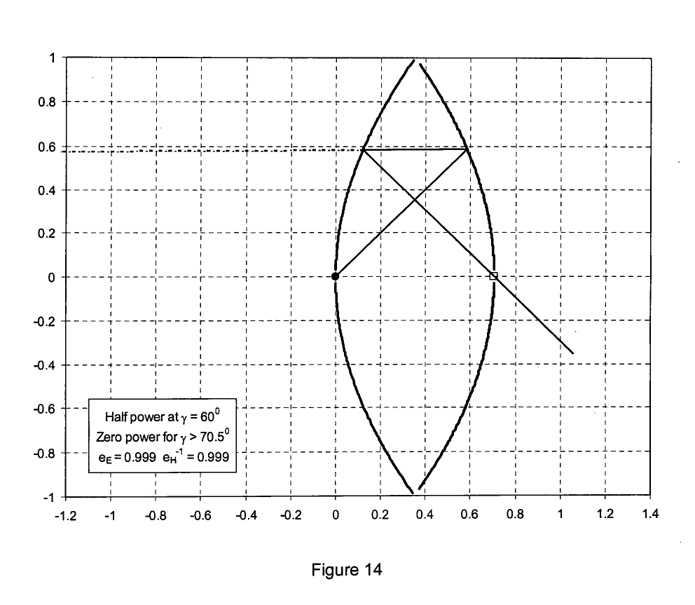

By looking at FIGS. 12 and 13 it can be seen that the angle β after a single reflection of a light ray is always less than the input angle α so the ellipse causes an initial concentration which increases with the eccentricity e_{E}. For 0<e_{E}<⅓, the angle γ after the second reflection of the ray is smaller than β so the reflection from the left limb of the hyperbola adds another stage of concentration. However for ⅓<e_{E}<1, γ is greater than β so the reflection from the right limb of the hyperbola actually reduces the concentration achieved by the first reflection. The overall effect is still a concentration. In the extreme case shown in FIG. 14 when e_{E} is nearly 1 the concentration and de-concentration cancel out so that the distribution emerging from the virtual source is the same as the input distribution from the real source. The ellipse is very nearly a parabola and reflects a ray from the source at its focus to one parallel with the axis. This ray is reflected from the virtually parabolic right limb of the hyperbola through its own focus which is the base of the nearly parabolic ellipse.

It can be seen that the following geometrical configuration of an ellipse and a hyperbola are demonstrated in FIGS. 12 and 13:
The pair of ellipse foci and pair of hyperbolae foci all lie on the same line, a common axis of rotation.
The left hand foci of both ellipse and hyperbola coincide.
The right hand focus of the hyperbola is at the right hand base of the ellipse (i.e. the point where it crosses the axis). This is the virtual source point.
The right hand focus of the ellipse is at the base of one or the other limb of the hyperbola (i.e. the point where the hyperbola crosses the axis). This is the real source point.

It can be shown that these conditions are true if the hyperbola parameters are chosen to have the following relationship with the ellipse parameters:

Distance between foci of hyperbola

2a_{H}e_{H}=a_{E}(1+e_{E})

### Eccentricity

$${e}_{H}^{- 1} = \{ \begin{matrix}( 1 - 3 {e}_{E} ) / ( 1 + {e}_{E} ) & if 0 < {e}_{E} \leq \frac{1}{3} \\ ( 3 {e}_{E} - 1 ) / ( 1 + {e}_{E} ) & if \frac{1}{3} \leq {e}_{E} \leq 1\end{matrix} \}$$

### Scaling

$${a}_{H} = \{ \begin{matrix}\frac{1}{2} {a}_{E} ( 1 - 3 {e}_{E} ) & if 0 < {e}_{E} \leq \frac{1}{3} \\ \frac{1}{2} {a}_{E} ( 3 {e}_{E} - 1 ) & if \frac{1}{3} \leq {e}_{E} \leq 1\end{matrix} \}$$

The source point will be at the centre of the left or right limbs of the hyperbola according to the range of the ellipse eccentricity, e_{E}:

$$\{ \begin{matrix}Left & if 0 < {e}_{E} \leq \frac{1}{3} \\ Right & if \frac{1}{3} \leq {e}_{E} \leq 1\end{matrix} \}$$

In the case e_{E}=⅓, the two limbs of the hyperbola merge into a single straight line perpendicular to the x-axis and the source is at the centre of the reflector. In other words, in this special case it is possible for the hyperbolic reflector to be flat or planar.

An analysis has been done for a Lambertian input distribution of total power π given by:

I(a)=cos a

FIG. 15 shows the output distribution from the virtual source for a range of values of e_{E}. In this way, embodiments of the invention can provide a set of designs having controllable beam profiles, by varying a single variable, in this case e_{E}. The corresponding placement and profile of the remainder of the apparatus can be automatically defined according to the relationships set out above. The scaling has been chosen to make the radius of the reflecting device unity. A precise point source has been assumed. For all values of e_{E} the device concentrates and narrows the beam to a greater or lesser extent, since the output angle γ is always smaller than the input angle α. The degree of concentration and beam narrowing varies from no effect at e_{E}=1 and increases as e_{E} decreases towards 0.

It will be understood that the present invention has been described above purely by way of example, and modification of detail can be made within the scope of the invention. Much attention has been directed to prolate spheroidal reflectors in the examples, but other geometries are possible.

Portions of one or both reflectors may not have the above illustrated idealised geometries, for example where practical considerations dictate, for example portions of the reflectors may be truncated or even omitted to accommodate a particularly shaped enclosure or for ease of manufacture or installation. One or both reflectors may depart from rotationally symmetric geometry when non-symmetrical beam patterns are desired, eg in vehicle headlights.

Light sources in the accompanying figures are shown schematically as point sources. In practice light may be emitted from a source having a finite size. Aspects of the invention have particular application to LEDs. Single high power LEDs are particularly suited to some embodiments, but it will be understood that groups of clusters of LEDs may also be employed as a light source. Common LEDs have a cylindrical form, and a light source may comprise a hexagonal packed cluster of seven LEDs. Larger clusters of 20 or more LEDs are also possible. It will be understood that in such cases not all emitted rays will follow the idealised paths illustrated above. Nevertheless, valid designs can still result by modelling the light source as a point. More complex embodiments of the invention may be provided by modelling the light source as a plurality of points resulting in a compound reflector which is the combination of a number of differently shaped surfaces. Again, not all emitted rays need be reflected according to the criteria illustrated above for a beneficial reflector arrangement to result.

Aspects of the invention may find use in a wide range of applications including torches or flashlights, spot lights, vehicle headlights, fibre optic systems and efficient fibre optics etc.

Each feature disclosed in the description, and (where appropriate) the claims and drawings may be provided independently or in any appropriate combination.

1. Beam forming apparatus for forming a beam in a forward direction along a beam axis, said apparatus comprising:
a light source;
a first reflector arranged to receive light from said source and to reflect it rearward, said first reflector having a first aperture therein;
a second reflector arranged to receive light from said first reflector and to reflect it forward through the aperture in said first reflector;
wherein the first reflector is arranged to direct incident light from said light source towards one or more foci rearward of the second reflector;
wherein said second reflector is hyperbolic.

2. Apparatus according to claim 1, wherein the second reflector is concave.

3. Apparatus according to claim 1, wherein the second reflector is planar.

4. Apparatus according to claim 1, wherein the second reflector is convex.

5. Apparatus according to claim 1, wherein the first reflector is elliptical.

6. Apparatus according to claim 5, wherein the focus of the hyperbolic second reflector which lies behind the second reflector is coincident with the rearmost focus of the elliptical first reflector.

7. Apparatus according to claim 1, wherein the focus of the hyperbolic second reflector which lies forward of the second reflector lies at the base of the first reflector, in the aperture of the first reflector.

8. Apparatus according to claim 5, wherein the foremost focus of the elliptical first reflector lies at the base of the second hyperbolic reflector.

9. Apparatus according to claim 8, wherein said light source is mounted to a heatsink, located rearward of the second reflector.

10. Apparatus according to claim 5, wherein the foci of said first and second reflectors lie along the beam axis.

11. Apparatus according to claim 5, wherein the light source is located at the foremost focus of the elliptical first reflector.

12. Apparatus according to claim 1, wherein the light source comprises one or more LEDs

13. Apparatus according to claim 1, wherein the second reflector includes a second aperture adapted to accommodate said light source.

14. Apparatus according to claim 1, wherein said first and second reflectors are arranged such that twice reflected light from said light source is directed towards a virtual focus in the aperture of said first reflector.

15. Apparatus according to claim 1, wherein said first and second reflectors are arranged such that twice reflected light from said light source is directed towards a focus forward of the aperture of said first reflector.
